(19) United States
(12) Patent Application Publication
(10) Pub. No.: US 2006/0179652 A1
(43) Pub. Date: Aug. 17, 2006

(54) Connecting flexible circuitry by stitching

(76) Inventors: Michael Petersen, Ottawa (CA); Allan Wilson, Ottawa (CA); Mykola Sherstyuk, Ottawa (CA)

Correspondence Address: JONES, TULLAR & COOPER, P.C., P.O. BOX 2266 EADS STATION, ARLINGTON, VA, 22202, US

(21) Appl. No.: 11/337,802

(22) Filed: Jan. 24, 2006

Related U.S. Application Data
(63) Continuation of application No. PCT/CA04/01081, filed on Jul. 25, 2004.

(30) Foreign Application Priority Data
Jul. 23, 2003 (CA) 2,436,131

(51) Int. Cl. G02F 1/1345

(52) U.S. Cl. 29/825; 349/149; 29/846

(57) ABSTRACT

A means is described of connecting multiple flexible printed circuit (FPC) tags. The means is suitable where electrical circuitry has been printed or otherwise applied to one side of flexible substrates, and where the circuitry of two such substrates is required to be brought into electrical continuity. In this method, a sewing, stitching or embroidery machine is used to hold juxtaposed conductive surfaces in electrical continuity by tension. In a variation of the means, conductive thread, wire or other material is used to create an electrically-conducting via between the relevant conductive surfaces of two or more such FPC tags.

### CROSS REFERENCE TO RELATED APPLICATIONS

This application is a continuation under 35 U.S.C. 120 and 365(c) of International Application No. PCT/CA2004/001081, which was filed on Jul. 25, 2004 and designates the Untied States.

### BACKGROUND OF THE INVENTION

1. Field of the Invention

This invention relates to a means of connecting multiple layers of flexible printed circuitry (FPC), and more specifically to facilitate stable electrical continuity between their respective circuits.

2. Description of the Background Art

Flexible electrical circuitry printed or otherwise mounted on the surface of flexible substrates such as polyesters, polyimides, coated paper, cellulose-based filled paper, and plastic-based (silica-filled polyethylene) paper is being used increasingly for electronics assembly. Lithographic printing using conductive inks is cost-effective and widely used. Flexible “tags” allow electronic components to be mounted together in minimal space and to be connected by printed traces or circuitry. The flexible nature of the substrate allows FPC tags to be used in situations where they may be deformed, without affecting adversely their electronic functions.

While the use of flexible substrates confers many advantages, it also creates a problem. How can multiple layers of FPC be connected in a way that allows stable electrical connectivity of their respective conductive pathways? This problem is compounded by the fact that the electrically conducting pathways are typically printed on one surface of the flexible substrate. Further, the various circuits may comprise dissimilar conductive inks or other conductive formulations (such as copper, aluminum, silver and other conductors) and different formulations within the various materials (such as a layer of pure metal, a colloidal suspension of a conductor in a variety of solvents, a conductor suspended in a polymer matrix, etc.). In addition, such various conductors may have different coefficients of expansion, different changes in resistance as a function of temperature and humidity, and different changes in electrical characteristics under deformation (e.g.: bending and folding).

Rigid printed circuit boards (PCBs) are typically joined electrically by vias. Vias are small holes drilled or otherwise cut through the PCB through which are flowed or deposited continuous layers of a conductive substance. Vias are less useful for joining layers of FPC due to the thinness of the FPC and the tendency of solid conductors to crack or break when the flexible substrates are deformed. Riveting and stapling have been used for this purpose, but are costly and do not lend themselves to high-speed production methods.

The proposed invention is a means of joining multiple layers of FPC using stitching (sewing or embroidery) techniques with or without the use of conductive thread or wire.

### SUMMARY OF THE INVENTION

The invention uses high-speed commercial sewing or embroidery machines to join two or more layers of FPC.

In accordance with an aspect of the present invention, there is described a method for connecting two or more FPC tags, each having one or more electrically conductive circuit(s) requiring electrically stable connection(s) to (a) corresponding circuit(s) on the other tag(s).

A single or multiple needle sewing or embroidery machine can be used to effect the solution.

The sewing may be done with any stitching method, including but not limited to chain stitching (ISO #101, 401), lock stitching (ISO #301) or zigzag bar tacking (ISO #304).

The sewing or embroidery machine can use either nonconductive thread or other material, or conductive thread or wire, as may be required.

Other aspects and features of the present invention will be readily apparent to those skilled in the art from a review of the following detailed description of preferred embodiments in conjunction with the accompanying drawings.

### BRIEF DESCRIPTION OF THE DRAWINGS

The invention will be further understood from the following description with reference to the drawings in which:

FIG. 1 is a block diagram showing a flexible card and a FPC tag requiring connection;

FIG. 2 is a schematic cross sectional view showing a cardboard and FPC tag to be connected where their respective conductive surfaces are juxtaposed;

FIG. 3 is a schematic cross sectional view showing a cardboard and FPC tag to be connected where their respective conductive surfaces are not juxtaposed;

FIG. 4 is a schematic cross sectional view of a sewing device joining a card and FPC tag with juxtaposed conductive surfaces;

FIG. 5 is a schematic cross sectional view of a card and FPC tag with juxtaposed conductive surfaces connected by chain stitching (ISO #101, 401);

FIG. 6 shows two sets of i/o tabs and their corresponding electrically conductive traces being connected by a continuous row of zigzag stitching using nonconductive thread.

FIG. 7 shows two sets of i/o tabs and their corresponding electrically conductive traces individually connected by bar tack stitching (ISO #304).

FIG. 8 is a schematic cross sectional view of three layers of FPC connected by a conductive bar tack (ISO #304).

### DETAILED DESCRIPTION OF THE PREFERRED EMBODIMENTS

FIGS. 1 through 6 depict an FPC tag being mounted to a flexible cardboard substrate on one surface of which has been printed a system of electrically conducting traces. The drawings could equally describe any type(s) of flexible substrate on the surface(s) of which has been mounted, by printing or other means, electrically conducting pathways.

Referring to FIG. 1, two flexible substrates are depicted. The smaller is a FPC tag (12) with 2 input/output (i/o) connecting tabs (14, 16) on one of its surfaces. The larger is a flexible cardboard substrate (18) on one surface of which has been applied a system of electrically conducting traces (20), be it by printing with silver or other electrically conducting ink, foil stamping, metal deposition or any other means.

The FPC tag (12) requires connecting to the cardboard (18) in such a way that the i/o tabs (14, 16) of the tag (12) are rendered electrically continuous with the printed traces (20) on the cardboard (18).

The strength of the connection is of interest as deformation of the flexible substrates can generate shearing forces at the points of contact, possibly affecting adversely the electrical characteristics of the system.

Accuracy of the alignment process is also important to facilitate the connection of FPC's in a mass-production environment.

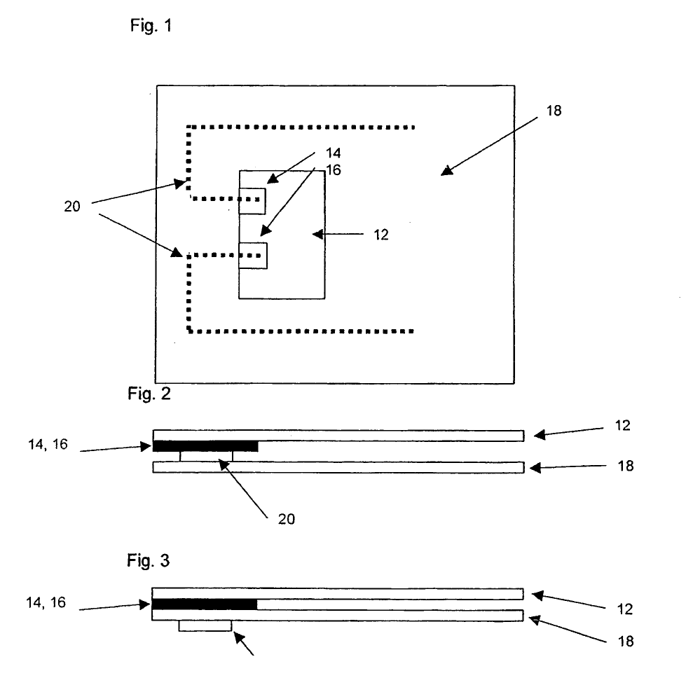

In FIG. 2, the FPC tag (12) and cardboard (18) have been arranged so their respective conducting surfaces are juxtaposed and the tag's i/o tabs (14, 16) are aligned with the corresponding conducting traces (20) on the cardboard.

FIG. 3 shows a cross-sectional view of an FPC tag (12) and a printed cardboard substrate (18) where the conducting surfaces are not juxtaposed, thereby interposing a dielectric barrier (cardboard) between the conducting surfaces.

FIGS. 2 and 3 illustrate a limitation affecting the connection of three or more FPC tags or other flexible substrates. It is not possible to juxtapose more than two conducting surfaces. With three or more FPC tags a dielectric barrier will of necessity be interposed between some tags.

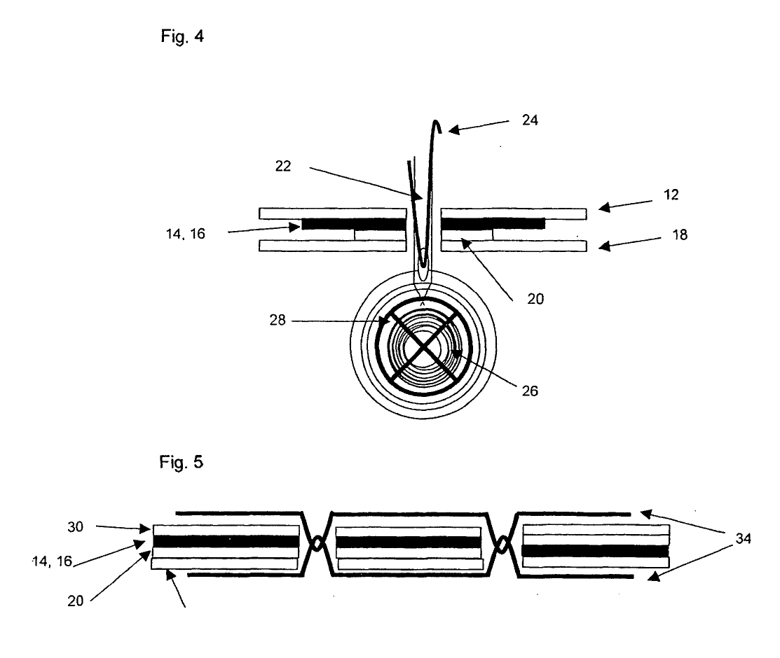

In FIG. 4, a common shuttle hook and bobbin sewing machine is used to connect the FPC tag (12) to a printed cardboard substrate (18), where the conductive surfaces are juxtaposed. The needle (22) penetrates the FPC tag (12) and cardboard substrate (18), creating a via. The needle (22) carries with it a thread (24) that is linked to another thread (26) carried in the bobbin (28), and a preset tension is applied as the machine moves and repeats the process. In this way, the stitching secures the approximated i/o tab (14, 16) and the appropriate conductive ink trace (20) in electrical continuity.

The needle may or may not pass through the conductive i/o tab and the electrical trace.

This method can be accomplished by any manner of sewing machine or device.

In a variation of the invention, conductive thread or wire may be used in the stitching process. If the stitching passes through the respective conducting pathways on the substrates of interest, it has the additional advantage of creating a continuous electrical pathway between the substrates to supplement the tension-generated direct physical contact between the two conductive surfaces. The use of conductive thread or wire is more suited to bar tack stitching (ISO #304), as described in FIG. 7 below.

FIG. 5 shows an FPC tag (30) connected to a printed cardboard substrate (32) by chain stitching (34). In this example, the conductive surfaces of the substrates are juxtaposed.

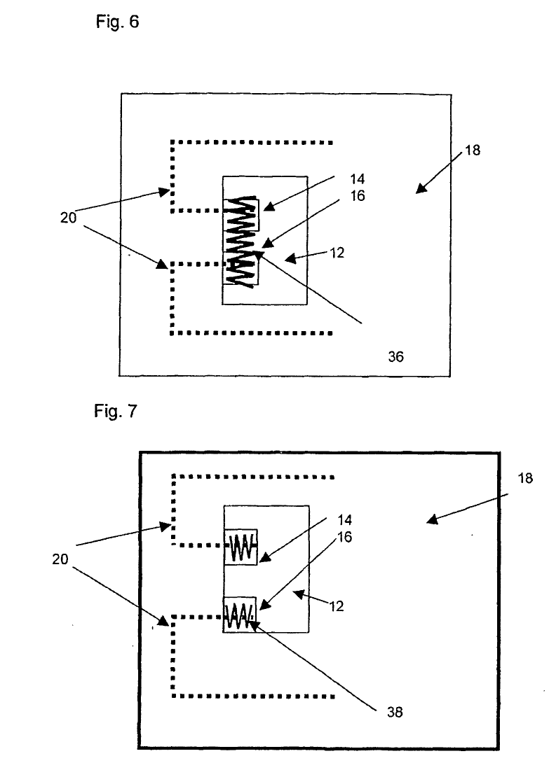

FIG. 6 demonstrates how a continuous row (36) of stitching with non-conducting thread can be used to connect multiple pairs of conductive pathways across two substrates whose conductive surfaces are in juxtaposition. A single row of zigzag or other manner of stitching can be run across the connection pairs of interest in a single machine operation, simplifying the assembly process and making it suitable for mass-production.

To ensure that electrical connections between FPC's are robust, it may be desirable to stitch the connections with electrically conducting thread, wire, or other conducting material. Where electrically conducting thread or wire is used, continuous zigzag stitching would short the electrically isolated pars of contacts.

Bar tack (ISO #304) or other repetitive in-place stitching (38) with conductive thread or wire can be used to join pairs or sets of conductive pathways, as shown in FIG. 7.

The use of electrically conducting thread or wire ensures maximum electrical connectivity between the conducting pathways of the FPC's or other substrates where the bar tack stitches penetrate the pathways of interest, providing a direct conducting pathway been the respective conducting pathways.

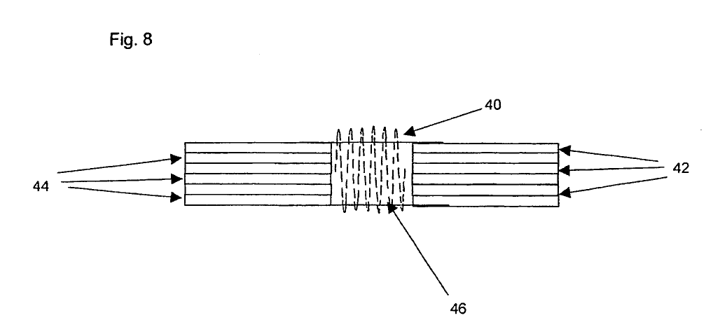

As seen in FIG. 8, the use of electrically conducting thread or wire (40) also permits the connection of more than two FPC's (42) where the conducting surfaces (44) cannot be juxtaposed. The stitching forms an electrically-conducting via (46) through any substrates whose orientation causes them to act as a dielectric.

While particular embodiments of the present invention have been shown and described, changes and modifications may be made to such embodiments without departing from the true scope of the invention.

1. A method of connecting two or more layers of flexible printed circuitry (FPC) each having at least one conducting pathway thereon, where electrical continuity between the respective conducting pathways is required, comprising:
providing two or more non-conductive, flexible substrates;
bringing such substrates into close juxtaposition whereby the at least one conducting pathway of one of said substrates is in electrical contact with the at least one conducting pathway of an other of said substrates; and
sewing such substrates together so as to maintain said conducting pathways in electrical contact with each other

2. The method of claim 1 wherein said sewing step is performed by a stitching, sewing or embroidery machine or device.

3. The method of claim, where non-conducting thread is used to hold the juxtaposed conducting surfaces of two FPC tags in electrically-conductive contact by tension.

4. The method of claim 2], where non-conducting thread is used to hold the juxtaposed conducting surfaces of two FPC tags in electrically-conductive contact by tension.

5. The method of claim 1, where conductive thread, wire or other material is used to create an electrically conducting pathway or via between the conducting surfaces of two or more juxtaposed or non-juxtaposed FPC tags by repetitive stitching through the conductive surfaces of interest on the respective FPC's.

6. The method of claim 2, where conductive thread, wire or other material is used to create an electrically conducting pathway or via between the conducting surfaces of two or more juxtaposed or non-juxtaposed FPC tags by repetitive stitching through the conductive surfaces of interest on the respective FPC's.

7. The method of claim 1, wherein said sewing is selected from the group comprising chain stitching, lock stitching and zigzag stitching.

8. A method of connecting two or more layers of flexible printed circuitry (FPC) each having at least one conducting pathway thereon, where electrical continuity between the respective conducting pathways is required, comprising:
providing two or more non-conductive, flexible substrates;
bringing such substrates into close juxtaposition whereby one of said substrates is in contact with the at least one conducting pathway of an other of said substrates so as to act as a dielectric with respect thereto; and
sewing such substrates together using an electrically conductive thread, wire or other material so as to create an electrically conductive pathway between the at least one conducting pathway of said one substrate and the at least one conducting pathway of said other substrate.

9. The method of claim 8, wherein said sewing is selected from the group comprising chain stitching, lock stitching and zigzag stitching.
